(19) United States
(12) Patent Application Publication
(10) Pub. No.: US 2013/0256214 A1
(43) Pub. Date: Oct. 3, 2013

(54) MULTI-CHANNEL MEMBRANE

(71) Applicants: Christian Dahlberg, Bempflingen (DE); Dietmar Oechsle, Schwabisch Gmund (DE); Erik Müller, Stuttgart (DE); Werner Wietschorke, Stuttgart (DE)

(72) Inventors: Christian Dahlberg, Bempflingen (DE); Dietmar Oechsle, Schwabisch Gmund (DE); Erik Müller, Stuttgart (DE); Werner Wietschorke, Stuttgart (DE)

(73) Assignee: MAHLE INTERNATIONAL GMBH, Stuttgart (DE)

(21) Appl. No.: 13/819,074

(22) PCT Filed: Jun. 17, 2011
(86) PCT No.: PCT/EP11/03015

§ 371 Date: Jun. 13, 2013

(30) Foreign Application Priority Data
Aug. 27, 2010 (DE) 10 2010 035 698.0

(51) Int. Cl. B01D 69/08

(52) U.S. Cl. CPC B01D 69/08; B01D 69/085
USPC 210/500.22; 425/71; 264/180

(57) ABSTRACT

A multi-channel membrane, in particular for treatment of liquids, includes at least one outer membrane surface and one inner membrane surface, which forms at least two longitudinally extending inner channels, which are enclosed by the outer membrane surface.

It is proposed that the outer membrane surface and the inner membrane surface each form an actively separating layer.

### CROSS REFERENCE TO RELATED APPLICATIONS

This application is a U.S. national stage application of PCT/EP2011/003015 filed on Jun. 17, 2011, and claims priority to, and incorporates by reference, German patent application No. 10 2010 035 698.0 filed on Aug. 27, 2010.

### TECHNICAL FIELD

1. Prior Art

The invention relates to a multi-channel membrane.

2. Background

A multi-channel membrane, in particular for treatment of liquids, comprising at least one outer membrane surface and one inner membrane surface, which forms at least two longitudinally extending inner channels, which are enclosed by the outer membrane surface, the outer membrane surface and the inner membrane surface each forming an actively separating layer, has already been proposed.

### SUMMARY

The invention is based on a multi-channel membrane, in particular for treatment of liquids, comprising at least one outer membrane surface and one inner membrane surface, which forms at least two longitudinally extending inner channels, which are enclosed by the outer membrane surface, the outer membrane surface and the inner membrane surface each forming an actively separating layer.

It is proposed that a median pore size of the actively separating layer of the outer membrane surface differs from a median pore size of the actively separating layer of the inner membrane surface. This allows versatility of use to be achieved, thereby allowing areas of use for the multi-channel membrane to be extended. The multi-channel membrane can preferably be used for a permeate flow from the inside outward, that is to say first through the inner membrane surface and then through the outer membrane surface, and for a permeate flow from the outside inward, that is to say first through the outer membrane surface and then through the inner membrane surface. Consequently, a feed, that is to say a liquid to be filtered, or the permeate, that is to say a filtered liquid, can be conducted in the inner channels. The actively separating layer is advantageously formed as an actively filtering layer. An “actively separating layer” is intended to be understood as meaning in particular a layer which, with respect to penetration, represents a resistance to at least one first component, in particular of a liquid. The actively separating layer advantageously represents at least substantially no resistance, with respect to penetration, to at least one second component of the liquid. The actively separating layer preferably allows different components, in particular of a liquid, to pass through differingly well. A “first component” is intended to be understood in this connection as meaning in particular a component which is intended to be filtered out or is filtered out from a liquid, such as for example particles and/or microorganisms. The actively separating layer preferably separates two components of different sizes from one another.

The actively separating layer advantageously has a median pore size that is formed as the smallest of the multi-channel membrane. An “average pore size” is intended to be understood as meaning in particular a mean value of a pore size distribution of the outer membrane surface and/or inner membrane surface. A pore size is intended also to be understood as meaning in particular a pore diameter. The average pore size, in particular of the actively separating layer, preferably defines a separating rate of the multi-channel membrane. The multi-channel membrane advantageously has a median pore size or separating rate of between 0.001 micrometer and 4 micrometers and particularly advantageously between 0.01 micrometer and 2 micrometers. The multi-channel membrane advantageously has a separating rate of up to 2000 daltons, whereby the multi-channel membrane can filter out a first component with a molecular weight of up to 2000 daltons or 2000 u. The multi-channel membrane can be used preferably for nanofiltration, ultrafiltration and/or microfiltration. The actively separating layer on the outer membrane surface preferably has a resistance to the first component that differs from a resistance to the first component of the actively separating layer on the inner membrane surface. In principle, the resistance to the first component of the actively separating layers may also be the same.

The outer membrane surface is preferably formed as an outer membrane wall. The inner membrane surface is preferably formed as an inner channel wall. An “outer membrane surface” is intended to be understood as meaning in particular a surface area which at least partially encloses the inner channels. The outer membrane surface is preferably longitudinally extending. The outer membrane surface preferably forms a cylindrical surface. The cylindrical outer membrane surface is preferably formed as a lateral surface of a cylinder. The multi-channel membrane is preferably formed as a multi-channel hollow-fiber membrane. The two actively separating layers are preferably formed by coagulation by a single coagulating agent. The multi-channel membrane is advantageously produced by extruding a polymer solution directly into the coagulating agent. The single coagulating agent preferably has in this case a liquid form. The inner channels advantageously each have a main direction of extent, which are arranged at least substantially parallel to a main direction of extent of the multi-channel membrane. The longitudinally extending inner channel advantageously has an inner channel diameter which lies between 0.3 millimeter and 3 millimeters and particularly advantageously between 0.5 millimeter and 2 millimeters. The multi-channel membrane preferably has a multi-channel membrane diameter which lies between 1 millimeter and 10 millimeters and particularly advantageously between 2 millimeters and 8 millimeters.

It is also proposed that the inner membrane surface forms three inner channels. This allows an advantageous packing density to be achieved. In addition, a higher efficiency of the multi-channel membrane can be achieved. The inner channels are preferably arranged symmetrically in relation to one another. In a symmetrical arrangement, central points of the inner channels advantageously lie on a circular line, particularly advantageously at three corners of an equilateral triangle. The inner channels are advantageously not arranged in series.

It is also proposed that the multi-channel membrane has a supporting layer, which is enclosed by the actively separating layer on the outer membrane surface and which encloses the actively separating layer on the inner membrane surface, the supporting layer having an at least substantially constant porosity. This allows particularly advantageous stability of the multi-channel membrane to be achieved, thereby allowing processing and/or production by machines. The porosity of the supporting layer is at least substantially constant, in particular along its cross section.

In particular, it is advantageous if a median pore size of the actively separating layers is at least approximately ten times smaller than a median pore size of the supporting layer. This allows a particularly advantageous multi-channel membrane to be provided. The average pore size of the supporting layer advantageously lies between 1 and 40 micrometers and particularly advantageously between 5 and 15 micrometers.

The invention is also based on a spinneret unit, in particular for producing a multi-channel membrane, comprising at least one extrusion unit, which forms at least one extrusion space for conducting a polymer solution, and comprising at least one internal-fluid feeding-in unit, which has at least two channels arranged within the extrusion space for conducting an internal fluid, the internal-fluid feeding-in unit having at least one supporting element, which is arranged within the extrusion space.

It is proposed that the internal-fluid feeding-in unit has at least one internal-fluid outlet opening, which is arranged within the extrusion space. This allows a particularly advantageous spinneret unit to be provided. This allows the multi-channel membrane to be produced particularly simply. The extrusion unit preferably forms an at least partially cylindrical unit. The channels are advantageously longitudinally extending. An “extrusion space” is intended to be understood as meaning in particular a space in which the polymer solution is conducted or extruded. The extrusion space is advantageously formed as the largest space within the spinneret unit, in particular as the largest space within the extrusion unit, which is intended for conducting the polymer solution. The extrusion space preferably has a main direction of extent which is arranged parallel to a main direction of extent of the inner channel unit, in particular parallel to a main direction of extent of the channels. “Within the extrusion space” is intended to be understood as meaning in particular an arrangement in which the element arranged within is enclosed by a wall of the extrusion unit. The elements arranged within the extrusion space advantageously come into contact with the polymer solution in an extrusion operation. The elements arranged within the extrusion space, in particular the channels, are advantageously enclosed by the polymer solution, in particular completely, in the extrusion operation.

A “supporting element” is intended to be understood as meaning in particular an element which, by its stiffness, fixes at least the inner channel unit in a fixed position. The supporting element advantageously accepts a force, in particular a force resulting from an extruded or flowing polymer solution, and passes on this force in particular to the extrusion unit. The supporting element preferably consists of the same material as the inner channel unit. The supporting element is, in particular, not a filter element. The at least one supporting element preferably positions the channels in the extrusion space. The channels advantageously each have a main direction of extent which is arranged parallel to a main direction of extent of the extrusion unit. The at least one supporting element preferably has a form conducive to flow. A “form conducive to flow” is intended to be understood as meaning in particular a form which either leaves a flow at least substantially uninfluenced or improves the flow, in particular, homogenizes the flow. In particular, the form conducive to flow does not cause any flow turbulence.

The at least one supporting element advantageously has an extent, oriented in an extrusion direction, which is significantly smaller than an extent of the extrusion space, oriented in the extrusion direction. This allows a particularly advantageous multi-channel membrane to be provided. A “significantly smaller extent” is intended to be understood as meaning in particular an extent which leaves at least one property of a multi-channel membrane produced from the polymer solution at least substantially unchanged. The extent of the supporting element in the extrusion direction is advantageously less than 20%, particularly advantageously less than 10% and most particularly advantageously less than 5%, of the extent of the extrusion space in the extrusion direction.

The at least one supporting element advantageously has a form tapering in a direction along the channels, consequently along the extrusion space. Particularly advantageously, the at least one supporting element has the tapering form in the extrusion direction. An “extrusion direction” is intended to be understood as meaning in particular a direction which corresponds to a direction of the extruded polymer solution, in particular in the extrusion space. A “tapering form” is intended to be understood as meaning in particular a form that decreases or becomes smaller. The tapering form is preferably formed as a decreasing width of the supporting element. A “width of the supporting element” is intended to be understood as meaning in particular an extent of the supporting element that extends along a cross section, i.e. that extends perpendicularly to a longitudinal axis of the channels and consequently perpendicularly to the extrusion direction.

It is also proposed that the extrusion unit has at least one polymer solution inflow and that at least the one supporting element is arranged downstream of the polymer solution inflow in an extrusion direction. This allows a particularly advantageous arrangement of the at least one supporting element to be achieved.

It is also advantageous if the extrusion unit has at least one polymer-solution outlet opening and the supporting element has at least one through-opening which is intended for the purpose of connecting the polymer solution inflow and the polymer-solution outlet opening in terms of flow. This allows the supporting element to be produced particularly easily. A “through-opening” is intended to be understood in this connection as meaning in particular an opening which is completely enclosed by material of the supporting element in at least one section, in particular in a cross section.

With particular preference, the at least one supporting element is formed as a bar. This allows a particularly advantageous supporting element to be provided.

It is also proposed that the extrusion space is formed at least partially as a funnel. This allows an advantageous flow of the polymer solution to be achieved.

Also proposed according to the invention is a method for producing a multi-channel membrane in which a polymer solution is extruded to form an outer membrane surface of the multi-channel membrane, the polymer solution being extruded between at least two channels to form an inner membrane surface of the multi-channel membrane, and an internal fluid that is, in terms of flow, separated from the extruded polymer solution being conducted through the at least two channels, the inner membrane surface and the outer membrane surface of the multi-channel membrane forming an actively separating layer, and a single coagulating agent being used and the polymer solution being extruded directly into the coagulating agent. This allows the multi-channel membrane to be produced particularly advantageously. This allows particularly easy coagulation to be achieved. This allows production costs of the multi-channel membrane to be reduced. The polymer solution is preferably conducted through or into only one single coagulating agent. The single coagulating agent advantageously has only one state of aggregation. The coagulating agent is preferably in a liquid form. “Directly” is intended to be understood as meaning in particular in a direct manner and, in particular, at least substantially without contact with other substances, such as in particular air. The coagulation advantageously takes place only in the one single coagulating agent. The inner membrane surface advantageously comes into contact with the internal fluid before the coagulating agent comes into contact with the outer membrane surface. The coagulating agent into which the polymer solution is extruded advantageously has a temperature of between 10° C. and 80° C., and particularly advantageously a temperature of between 20° C. and 70° C. The outer membrane surface preferably forms a cylindrical surface. Three inner channel surfaces advantageously form the inner membrane surface, i.e. the polymer solution is extruded between three channels. The inner channel surfaces advantageously each form a cylindrical surface. The polymer solution is advantageously extruded at an extrusion rate which lies between 0.5 meter per minute and 15 meters per minute, particularly advantageously between 1 meter per minute and 10 meters per minute.

The polymer solution preferably consists of the constituents polyethersulfone, N-methyl-2-pyrrolidone and polyvinylpyrrolidone. Particularly preferably, the polymer solution consists of the constituents polyethersulfone, N-methyl-2-pyrrolidone, polyvinylpyrrolidone, water and glycerin. The polymer solution advantageously has a percentage of polyethersulfone which lies between 3% and 40% and particularly advantageously between 5% and 35%. The polymer solution advantageously has a percentage of N-methyl-2-pyrrolidone which lies between 40% and 90% and particularly advantageously between 50% and 80%. The polymer solution advantageously has a percentage of polyvinylpyrrolidone which lies between 3% and 40% and particularly advantageously between 5% and 30%. The polymer solution advantageously has a percentage of water which lies between 0% and 20% and particularly advantageously between 1% and 10%. The polymer solution advantageously has a percentage of glycerin which lies between 0% and 20% and particularly advantageously between 1% and 10%.

The internal fluid preferably consists at least partially of water. The internal fluid advantageously consists of at least one constituent and particularly advantageously of at least two constituents. The internal fluid preferably consists of the constituent water and particularly preferably of the constituents water and N-methyl-2-pyrrolidone. The internal fluid, which consists of the constituents water and N-methyl-2-pyrrolidone, advantageously has a percentage of water which lies between 10% and 90% and particularly advantageously between 20% and 80%. The internal fluid, which consists of the constituents water and N-methyl-2-pyrrolidone, advantageously has a percentage of N-methyl-2-pyrrolidone which lies between 10% and 90% and particularly advantageously between 20% and 80%.

It is also proposed that a median pore size of the actively separating layer on the inner membrane surface and/or a median pore size of the actively separating layer on the outer membrane surface are set according to requirements. This allows a multi-channel membrane which is adapted to a requirement or to an area of use to be produced. The actively separating layers can advantageously be set independently of one another. The average pore size of the actively separating layer on the outer membrane surface advantageously differs from the average pore size of the actively separating layer on the inner membrane surface. In principle, the pore sizes of the actively separating layers may also be substantially the same. “Substantially the same” is intended to be understood as meaning in particular a deviation of the average pore sizes of at most five percent, particularly advantageously of at most three percent and most particularly advantageously of at most one percent.

In particular, it is advantageous if the internal fluid corresponds at least partially to the coagulating agent. This allows particularly easy production of the multi-channel membrane to be achieved. “At least partially” is intended to be understood in this connection as meaning in particular that the internal fluid consists at least of one constituent that corresponds at least to one constituent of the coagulating agent.

Furthermore, it is advantageous if water is used as the coagulating agent. This allows the production costs to be reduced further.

It is also proposed that a material property of the multi-channel membrane is changed by the use of plasma. This allows an advantageous multi-channel membrane to be produced. The material property is preferably changed by ultraviolet light (UV light). The UV light is advantageously used to hydrophilicize the multi-channel membrane. The plasma is preferably formed as oxygen plasma. The hydrophilicizing advantageously takes place in the plasma, in particular in the oxygen plasma. The changing of the material property of the multi-channel membrane by the use of plasma may be performed for example by an apparatus such as that described in the document DE 102 36 717.

### BRIEF DESCRIPTION OF THE DRAWINGS

Further advantages will become evident from the following description of the drawings. The drawings illustrate three exemplary embodiments of the spinneret unit by means of which the multi-channel membrane according to the invention is produced by the method according to the invention. The description and the claims contain numerous features in combination. A person skilled in the art will also expediently consider the features individually and combine them to form meaningful further combinations.

FIG. 1 is a cross sectional view of a multi-channel membrane,

FIG. 2 is a partially longitudinal sectional view of the multi-channel membrane,

FIG. 3 is a plan view of a spinneret unit,

FIG. 4 is a side view of the spinneret unit,

FIG. 5 is a longitudinal sectional view of the spinneret unit along sectional lines A-A,

FIG. 6 is a micrograph of a cross section of the multi-channel membrane according to the invention with two actively separating layers,

FIG. 7 is a micrograph of a cross section of a multi-channel membrane with one actively separating layer,

FIG. 8 is a longitudinal sectional view of an alternatively formed spinneret unit along sectional lines A-A,

FIG. 9 is a cross sectional view of the alternatively formed spinneret unit along sectional lines B-B,

FIG. 10 is a cross sectional view of a third exemplary embodiment of a spinneret unit, and

FIG. 11 is a partially longitudinal sectional view of the third exemplary embodiment of the spinneret unit along sectional lines C-C.

### DETAILED DESCRIPTION

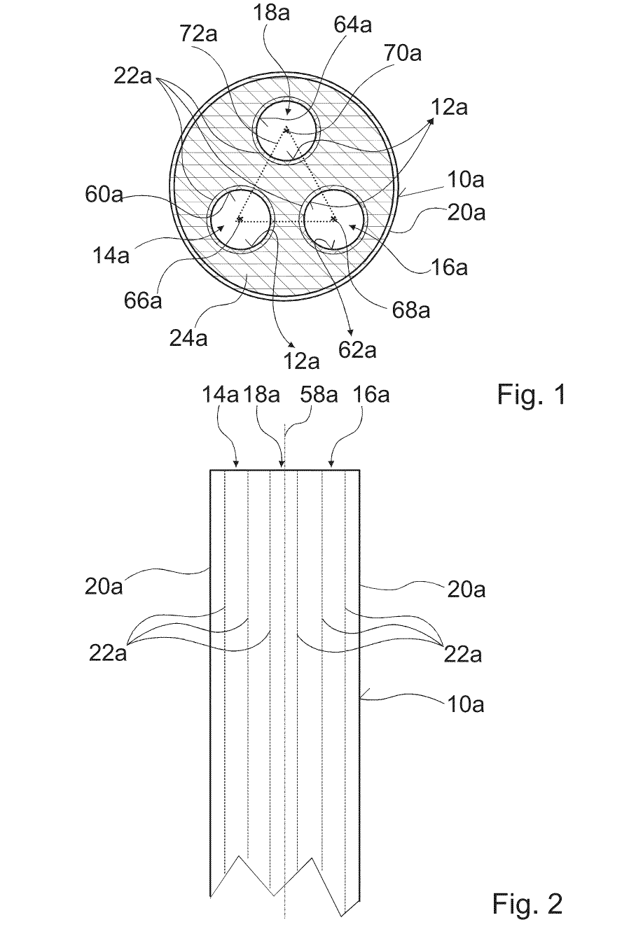

FIGS. 1 to 6 illustrate a multi-channel membrane and a spinneret unit intended for producing the multi-channel membrane. The multi-channel membrane is cylindrically formed. In FIG. 1, the multi-channel membrane is represented in a cross section. The cross section extends perpendicularly to a longitudinal axis 58a of the cylindrical multi-channel membrane. The multi-channel membrane is used in a liquid filter, in particular in a water filter. The multi-channel membrane is intended for treatment of liquids, in particular for preparing water. The multi-channel membrane is intended in particular for cross-flow filtration or dead-end filtration. The multi-channel membrane is formed as a filtration multi-channel membrane.

The multi-channel membrane has a cylindrical outer membrane surface 10a and an inner membrane surface 12a. The inner membrane surface 12a is formed by three cylindrical inner channel surfaces 60a, 62a, 64a. The inner channel surfaces 60a, 62a, 64a each form a longitudinally extending inner channel 14a, 16a, 18a. The inner membrane surface 12a consequently forms three longitudinally extending inner channels 14a, 16a, 18a. The outer membrane surface 10a encloses the inner membrane surface 12a, and consequently the longitudinally extending inner channels 14a, 16a, 18a. The inner channels 14a, 16a, 18a are intended for transporting a filtering liquid or filtered liquid, depending on in which direction a permeate flows or in which direction a permeation takes place.

The three inner channels 14a, 16a, 18a are separate from one another. The three inner channels 14a, 16a, 18a are cylindrically formed. They extend from one end to another end of the multi-channel membrane. An inner channel 14a, 16a, 18a thereby forms in each case a through-hole. Each through-hole, and consequently each of the three inner channels 14a, 16a, 18a, has an at least substantially circular inner channel opening. The three inner channels 14a, 16a, 18a are arranged symmetrically in relation to one another. The inner channel openings, and consequently the inner channels 14a, 16a, 18a, each have a central point 66a, 68a, 70a, which are arranged at three corners of an equilateral or equiangular triangle 72a. The outer membrane surface 10a and the inner membrane surface 12a each form an actively separating layer 20a, 22a. The actively separating layers 20a, 22a are each formed as an actively filtering layer. The outer membrane surface 10a forms an outer actively separating layer 20a of the multi-channel membrane. The inner membrane surface 12a, that is to say the three inner channel surfaces 60a, 62a, 64a, forms/form an inner actively separating layer 22a of the multi-channel membrane. The actively separating layers 20a, 22a act simultaneously, i.e. the liquid to be filtered is double-filtered.

The actively separating layers 20a, 22a are porous. The actively separating layer 20a on the outer membrane surface 10a and the actively separating layer 22a on the inner membrane surface 12a each have a median pore size. The average pore size of the actively separating layer 20a differs from the average pore size of the actively separating layer 22a. In principle, the pore sizes of the actively separating layers 20a, 22a may also be the same. The actively separating layer 20a on the outer membrane surface 10a and the actively separating layer 22a on the inner membrane surface 12a are set to a requirement. The actively separating layers 20a, 22a can be set or controlled independently of one another.

For supporting the actively separating layers 20a, 22a and for stabilization, the multi-channel membrane has a supporting layer 24a. The supporting layer 24a of the multi-channel membrane is enclosed by the actively separating layer 20a on the outer membrane surface 10a. The actively separating layer 22a on the inner membrane surface 12a is enclosed by the supporting layer 24a of the multi-channel membrane.

The supporting layer 24a has a high permeability in comparison with the actively separating layers 20a, 22a. The actively separating layers 20a, 22a are very thin and impermeable in comparison with the supporting layer 24a. The actively separating layers 20a, 22a and the supporting layer 24a consist of an identical polymer. The multi-channel membrane is consequently configured as an integral-asymmetric multi-channel membrane.

The supporting layer 24a is porous. The supporting layer 24a has a median pore size. The average pore size of the supporting layer 24a differs from the average pore size of the actively separating layer 20a and from the average pore size of the actively separating layer 22a. The average pore size of the supporting layer 24a is greater than the average pore size of the actively separating layer 20a and than the average pore size of the actively separating layer 22a. The average pore size of the supporting layer 24a is substantially constant along the cross section and along the longitudinal axis 58a. The supporting layer 24a has a substantially constant porosity. The porosity of the supporting layer 24a is great in comparison with the average pore size of the actively separating layer 20a and in comparison with the average pore size of the actively separating layer 22a. The average pore sizes of the actively separating layers 20a, 22a are approximately ten times less than the average pore size of the supporting layer 24a.

In this exemplary embodiment, the actively separating layers 20a, 22a and the supporting layer 24a, and consequently the multi-channel membrane, consist of a polymer with an increased hydrophilicity, i.e. with an increased water wettability. The multi-channel membrane consists of polyethersulfone (PES). The solvent N-methyl-2-pyrrolidone (NMP) is used as the solvent for the polymer. Polyvinylpyrrolidone (PVP) is used for the polymerization. A polymer solution consequently consists of polyethersulfone, N-methyl-2-pyrrolidone and polyvinylpyrrolidone. In this exemplary embodiment, the polymer solution is made up of 30% polyethersulfone, 50% N-methyl-2-pyrrolidone, 10% polyvinylpyrrolidone, 5% water and 5% glycerin.

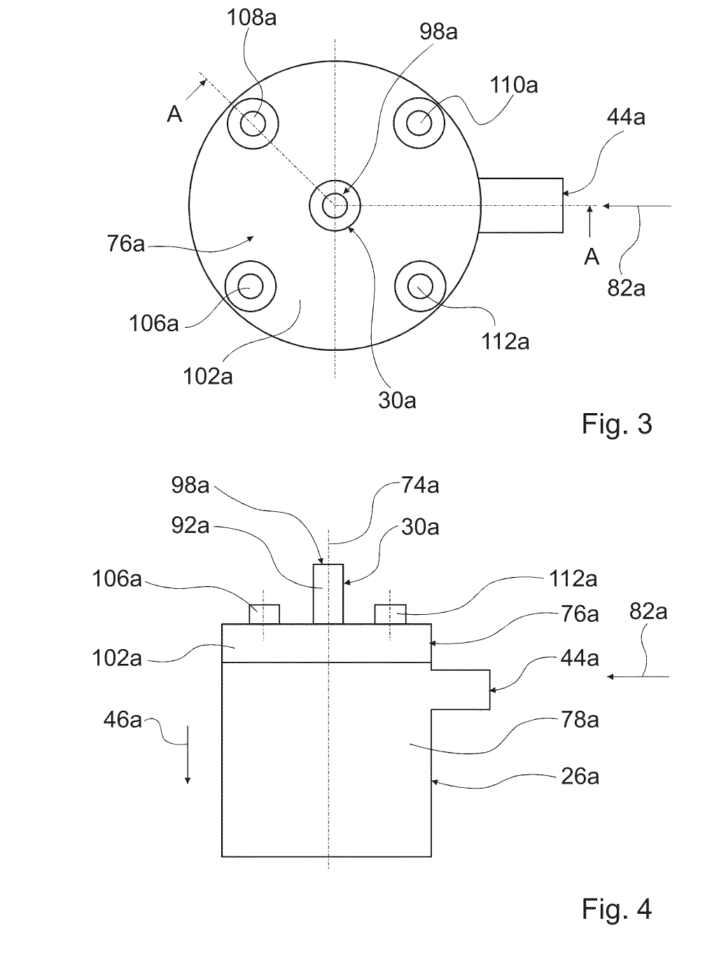

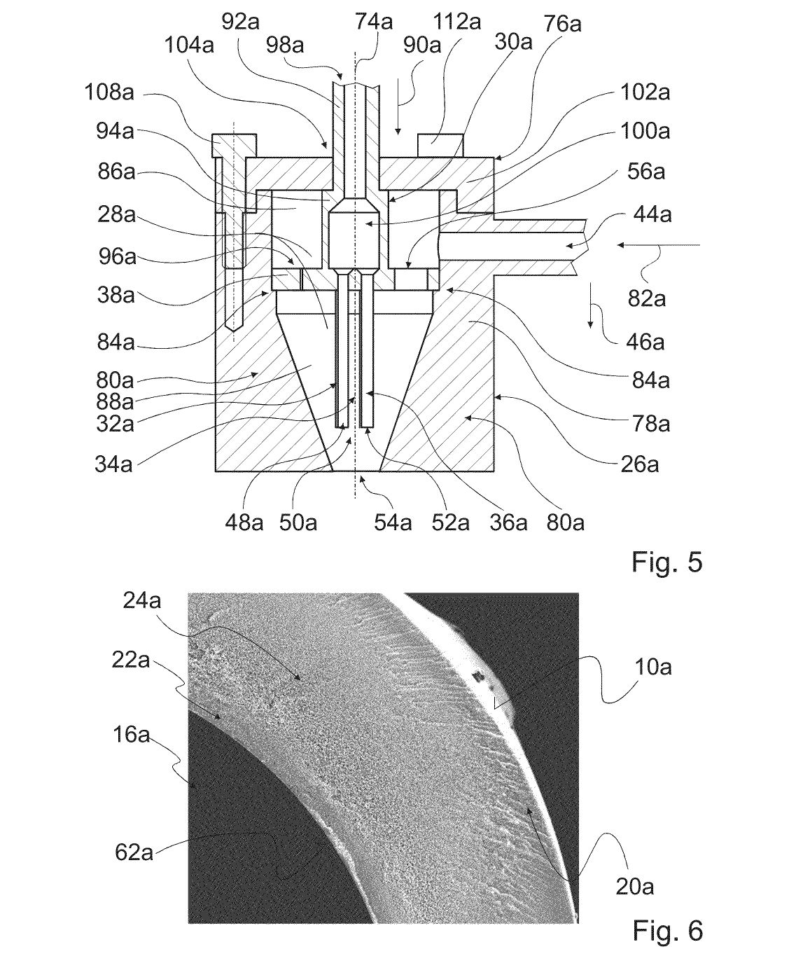

The multi-channel membrane is produced by a spinneret unit (cf. FIGS. 3 to 5). In FIG. 3, the spinneret unit is represented in a plan view. In FIG. 4, the spinneret unit is represented in a side view. In FIG. 5, the spinneret unit is represented in a longitudinal section along a sectional line A-A according to FIG. 3. The longitudinal section extends parallel to an extrusion direction 46a, and consequently to a longitudinal axis 74a of the spinneret unit.

The spinneret unit is formed in three parts. The spinneret unit has an extrusion unit 26a, an internal-fluid feeding-in unit 30a and a cover unit 76a.

For conducting the polymer solution, the spinneret unit has the extrusion unit 26a. The extrusion unit 26a comprises a single longitudinally extending extrusion element 78a. The extrusion element 78a forms an extrusion space 28a, in which the polymer solution is conducted, that is to say extruded. The polymer solution is extruded in the extrusion direction 46a in the extrusion space 28a. The extrusion element 78a forms a longitudinally extending extrusion space 28a. The extrusion element forms a partially funnel-shaped or conical extrusion space 28a. The extrusion space 28a is enclosed by a wall 80a of the extrusion element 78a. The wall 80a consequently defines the extrusion space 28a. In this exemplary embodiment, the extrusion unit 26a is formed as one piece. In principle, the extrusion unit 26a may also be formed as more than one piece, the multi-piece extrusion unit being interconnected in particular by a thermal process for joining by material bonding, such as for example soldering, brazing or welding, and forming an assembly component, which is fitted in the spinneret unit in a single assembly step.

For feeding the polymer solution into the extrusion space 28a, the extrusion element 78a has a polymer solution inflow 44a. The polymer solution inflow 44a extends through the wall 80a perpendicularly to the extrusion direction 46a, and consequently perpendicularly to the longitudinal axis 74a. A direction of polymer solution inflow 82a in the polymer solution inflow 44a is perpendicular to the extrusion direction 46a and perpendicular to the longitudinal axis 74a. The polymer solution inflow 44a is oriented from the outside inward. The polymer solution inflow 44a is formed as a bore in the wall 80a of the extrusion element 78a, which is connected in terms of flow to the extrusion space 28a.

For discharging the polymer solution from the extrusion space 28a, that is to say from the spinneret unit, the extrusion unit 26a, and consequently the extrusion element 78a, has a polymer-solution outlet opening 54a. The polymer-solution outlet opening 54a is oriented in the extrusion direction 46a. The polymer-solution outlet opening 54a is arranged downstream of the polymer solution inflow 44a in the extrusion direction 46a. The polymer solution leaves the spinneret unit from the polymer-solution outlet opening 54a. A central point of the extrusion element 78a corresponds to a central point of the polymer-solution outlet opening 54a. The polymer-solution outlet opening 54a is oriented from above downward. The polymer-solution outlet opening 54a has a diameter which is greater than a diameter of the polymer solution inflow 44a. In this exemplary embodiment, the diameter of the polymer-solution outlet opening 54a is 4 millimeters.

For supporting and arranging the internal-fluid feeding-in unit 30a, the extrusion element 78a has a supporting element 84a. The supporting element 84a is arranged within the extrusion space 28a. The supporting element 84a is arranged along a circumference of the extrusion element 78a within the wall 80a. The supporting element 84a is arranged downstream of the polymer solution inflow 44a in the extrusion direction 46a, and consequently in the direction of polymer solution inflow 82a. The supporting element 84a is arranged under the polymer solution inflow 44a with respect to a direction that is oriented from the cover unit 76a to the polymer-solution outlet opening 54a. The supporting element 84a is made of the same material as the extrusion element 78a. The supporting element 84a is formed as one piece with the extrusion element 78a. The supporting element 84a is part of the wall 80a of the extrusion element 78a. The supporting element 84a is formed as a taper of the extrusion space 28a, and consequently as the material of the extrusion element 78a within the extrusion space 28a.

The supporting element 84a defines a plane which is arranged perpendicularly to the extrusion direction 46a, and consequently perpendicularly to the longitudinal axis 74a. This plane, that is to say the supporting element 84a, subdivides the extrusion space 28a into a polymer-solution inflow space 86a and a polymer-solution outflow space 88a. The polymer-solution inflow space 86a is connected directly in terms of flow to the polymer solution inflow 44a of the extrusion element 78a. The polymer-solution outflow space 88a is connected in terms of flow directly to the polymer-solution outlet opening 54a of the extrusion element 78a. In an extrusion operation, the polymer solution runs out of the polymer solution inflow 44a firstly into the polymer-solution inflow space 86a and subsequently into the polymer-solution outflow space 88a.

The polymer-solution inflow space 86a is cylindrically formed. The polymer-solution outflow space 88a of the extrusion space 28a is partially formed as a funnel. The polymer-solution inflow space 86a and the polymer-solution outflow space 88a have different diameters. The diameter of the polymer-solution inflow space 86a is greater than the diameter of the polymer-solution outflow space 88a. After a certain distance, the diameter of the polymer-solution outflow space 88a becomes continuously smaller here in the extrusion direction 46a, down to the diameter of the polymer-solution outlet opening 54a.

For conducting an internal fluid, and consequently for forming the three inner channels 14a, 16a, 18a of the multi-channel membrane, and for forming the actively separating layer 22a on the inner membrane surface 12a, the spinneret unit has the internal-fluid feeding-in unit 30a. For this purpose, the internal-fluid feeding-in unit 30a has three longitudinally extending channels 32a, 34a, 36a. The channels 32a, 34a, 36a separate, in terms of flow, the polymer solution from the internal fluid in the spinneret unit. The three channels 32a, 34a, 36a are arranged in the spinneret unit within the extrusion space 28a.

The channels 32a, 34a, 36a each have in cross section a through-opening, through which the internal fluid is conducted. The respective through-openings each have a diameter which is constant along the respective channel 32a, 34a, 36a. The channels 32a, 34a, 36a each have the same diameter. The internal-fluid feeding-in unit 30a, in particular the channels 32a, 34a, 36a, define an interior space of the spinneret unit through which an internal fluid is conducted. A direction of internal fluid flow 90a corresponds to the extrusion direction 46a. The direction of internal fluid flow 90a extends parallel to the longitudinal axis 74a.

The three channels 32a, 34a, 36a are arranged symmetrically in relation to one another. The through-openings, and consequently the channels 32a, 34a, 36a, each have a central point. The central points of the through-openings, and consequently the central points of the channels 32a, 34a, 36a, are arranged at three corners of an equilateral or equiangular triangle. The central points of the channels 32a, 34a, 36a correspond substantially to the central points 66a, 68a, 70a of the inner channels 14a, 16a, 18a of the multi-channel membrane. The diameter of the through-opening of the respective channel 32a, 34a, 36a is in each case 1.1 millimeters.

The internal-fluid feeding-in unit 30a also has an inflow element 92a, a transitional element 94a and a supporting element 38a. The inflow element 92a, the transitional element 94a and the supporting element 38a are arranged one after the other in the direction of internal fluid flow 90a. The transitional element 94a is arranged downstream of the inflow element 92a and upstream of the supporting element 38a in the direction of internal fluid flow 90a. The transitional element 94a is arranged between the inflow element 92a and the supporting element 38a. The internal fluid consequently flows firstly through the inflow element 92a, then through the transitional element 94a and then through the supporting element 38a and the channels 32a, 34a, 36a. The inflow element 92a, the transitional element 94a and the supporting element 38a are arranged coaxially in relation to one another. The transitional element 94a connects the inflow element 92a and the supporting element 38a to one another.

The wall 80a of the extrusion element 78a partially encloses the internal-fluid feeding-in unit 30a. The wall 80a of the extrusion element 78a encloses the transitional element 94a, the supporting element 38a and the three channels 32a, 34a, 36a. The transitional element 94a, the supporting element 38a and the three channels 32a, 34a, 36a are arranged within the extrusion space 28a, and consequently within the extrusion element 78a. The supporting element 38a and the transitional element 94a are arranged within the polymer-solution inflow space 86a. The three channels 32a, 34a, 36a are arranged partially in the polymer-solution inflow space 86a and partially in the polymer-solution outflow space 88a. In this case, the channels 32a, 34a, 36a are arranged with over 50 percent of their axial extent within the funnel-shaped polymer-solution outflow space 88a and with over 70 percent of their axial extent within the polymer-solution outflow space 88a. The channels 32a, 34a, 36a all have the same axial extent. The internal-fluid feeding-in unit 30a and the extrusion unit 26a are arranged coaxially in relation to one another.

The inflow element 92a, the transitional element 94a and the supporting element 38a each have different diameters. The channels 32a, 34a, 36a each have the same diameters, the diameters of the channels 32a, 34a, 36a differing from the diameters of the inflow element 92a, of the transitional element 94a and of the supporting element 38a. The diameter of the inflow element 92a is in this case formed as the smallest in comparison with the diameter of the transitional element 94a and the diameter of the supporting element 38a. The diameter of the supporting element 38a is in this case formed as the greatest in comparison with the diameter of the inflow element 92a, the diameter of the transitional element 94a and the diameters of the channels 32a, 34a, 36a. The diameter of the channels 32a, 34a, 36a is formed as the smallest in comparison with the diameter of the inflow element 92a, the diameter of the transitional element 94a and the diameter of the supporting element 38a. The diameter of the individual channels 32a, 34a, 36a is 1.2 millimeters. Consequently, each individual channel 32a, 34a, 36a has a wall thickness of 0.1 millimeter.

The diameter of the supporting element 38a is greater than the diameter of the polymer-solution outflow space 88a and less than the diameter of the polymer-solution inflow space 86a. In this exemplary embodiment, the diameter of the supporting element 38a is minimally less than the diameter of the polymer-solution inflow space 86a. The supporting element 38a has the diameter by which the supporting element 38a lies exactly against a circumference of the polymer-solution inflow space 86a or against the material of the extrusion element 78a in the polymer-solution inflow space 86a. The supporting element 38a lies against the supporting element 84a. The supporting element 38a is supported in the extrusion direction 46a on the supporting element 84a, and consequently on the extrusion element 78a within the extrusion space 28a. The internal-fluid feeding-in unit 30a forms by the supporting element 38a an interlocking engagement, acting in the extrusion direction 46a, with the extrusion element 78a. The supporting element 38a forms the interlocking engagement in the extrusion direction 46a with the extrusion element 78a within the extrusion space 28a. The supporting element 38a accepts a force, produced by the polymer solution flowing in the extrusion space 28a, in the extrusion operation and passes this force on to the extrusion element 78a. As a result, the supporting element 38a fixes the internal-fluid feeding-in unit 30a, in particular the channels 32a, 34a, 36a, within the extrusion space 28a.

The supporting of the supporting element 38a on the supporting element 84a has the effect that the supporting element 38a is arranged within the extrusion space 28a. The supporting element 38a is arranged within the polymer-solution inflow space 86a. The supporting element 38a is arranged downstream of the polymer solution inflow 44a in the extrusion direction 46a, and consequently in the direction of polymer solution inflow 82a. The supporting element 38a is arranged under the polymer solution inflow 44a with respect to the direction that is oriented from the cover unit 76a to the polymer-solution outlet opening 54a. The supporting element 38a is arranged upstream of the polymer-solution outlet opening 54a in the extrusion direction 46a. The supporting element 38a is made of an identical material to the internal fluid unit 30a. The supporting element 38a is formed as one piece with the internal fluid unit 30a. The supporting element 38a is part of a wall of the internal fluid unit 30a.

For the connection of the polymer-solution inflow space 86a and the polymer-solution outflow space 88a in terms of flow, and consequently for the connection of the polymer solution inflow 44a and the polymer-solution outlet opening 54a in terms of flow, the supporting element 38a has a through-opening 56a. The through-opening 56a is completely enclosed by the material of the supporting element 38a in a cross section that extends through the supporting element 38a. The through-opening 56a is arranged at the polymer solution inflow 44a. The through-opening 56a penetrates the supporting element 38a parallel to the longitudinal axis 74a.

The through-opening 56a has a diameter. The diameter of the through-opening 56a corresponds approximately to the diameter of the polymer solution inflow 44a. The diameter of the through-opening 56a is less than the diameter of the polymer-solution outlet opening 54a. The through-opening 56a is formed as a bore in the supporting element 38a. The diameter of the through-opening 56a is 3 millimeters.

For improving flow characteristics of the polymer solution in the extrusion space 28a, the supporting element 38a has a venting opening 96a. The venting opening 96a has a diameter which is less than the diameter of the through-opening 56a. The venting opening 96a is formed as a bore in the supporting element 38a.

For feeding the internal fluid into the internal-fluid feeding-in unit 30a, the internal-fluid feeding-in unit 30a has an internal fluid inflow 98a. The internal fluid inflow 98a extends along the longitudinal axis 74a of the internal-fluid feeding-in unit 30a through the inflow element 92a. The internal fluid inflow 98a extends along a longitudinal axis of the inflow element 92a, which corresponds to the longitudinal axis 74a. The inflow element 92a consequently has the internal fluid inflow 98a. The internal fluid inflow 98a is oriented from above downward. The internal fluid inflow 98a is formed as a bore in the inflow element 92a.

For the connection of the channels 32a, 34a, 36a and the internal fluid inflow 98a in terms of flow, the internal-fluid feeding-in unit 30a has a transitional space 100a. The transitional space 100a extends along the longitudinal axis 74a of the internal-fluid feeding-in unit 30a through the transitional element 94a. The transitional space 100a extends along a longitudinal axis of the transitional element 94a, which corresponds to the longitudinal axis 74a. The transitional element 94a consequently has the transitional space 100a. The transitional space 100a and the internal fluid inflow 94a are arranged coaxially in relation to one another. The three channels 32a, 34a, 36a, and consequently the three through-openings of the channels 32a, 34a, 36a, are all arranged within the transitional space 100a in a cross section that extends through the transitional element 94a and is aligned perpendicularly to the extrusion direction 46a, and consequently perpendicularly to the longitudinal axis 74a. Each channel 32a, 34a, 36a is connected in terms of flow to the transitional space 100a.

For the connection of the transitional space 100a and the extrusion space 28a in terms of flow, the channels 32a, 34a, 36a extend along the longitudinal axis 74a, and consequently perpendicularly through the supporting element 38a. The supporting element 38a consequently positions the channels 32a, 34a, 36a in relation to one another. The channels 32a, 34a, 36a completely penetrate the supporting element 38a along the longitudinal axis 74a and connect the extrusion space 28a, in terms of flow, to the transitional space 100a, and consequently to the internal fluid inflow 98a. The channels 32a, 34a, 36a connect the transitional space 100a, and consequently the inflow 98a and the funnel-shaped polymer-solution outflow space 88a, to one another in terms of flow.

For discharging the internal fluid, the internal-fluid feeding-in unit 30a has three internal-fluid outlet openings 48a, 50a, 52a. The internal-fluid outlet openings 48a, 50a, 52a are each formed by a channel end of the channels 32a, 34a, 36a. The channel 32a has the internal-fluid outlet opening 48a, the channel 34a has the internal-fluid outlet opening 50a and the channel 36a has the internal-fluid outlet opening 52a. The internal-fluid outlet openings 48a, 50a, 52a, and consequently the three channel ends of the channels 32a, 34a, 36a, are connected, in terms of flow, to the internal fluid inflow 98a. The internal-fluid outlet openings 48a, 50a, 52a each have a central point, which corresponds in each case to the corresponding central point of the associated through-opening of the channel 32a, 34a, 36a.

The internal-fluid outlet openings 48a, 50a, 52a are all arranged or positioned within the extrusion space 28a. The internal-fluid outlet openings 48a, 50a, 52a are all arranged within the funnel-shaped polymer-solution outflow space 88a. The internal-fluid outlet openings 48a, 50a, 52a are all arranged upstream of the polymer-solution outlet opening 54a in the extrusion direction 46a. A conduction of the internal fluid consequently ends at a distance from a conduction of the polymer solution. The internal-fluid outlet openings 48a, 50a, 52a are all arranged in one plane. The plane in which the internal-fluid outlet openings 48a, 50a, 52a are arranged extends perpendicularly to the extrusion direction 46a and perpendicularly to the direction of internal fluid flow 90a.

The internal fluid inflow 98a, the transitional space 100a and the internal-fluid outlet openings 48a, 50a, 52a each have different diameters. The diameter of the transitional space 100a is in this case formed as the greatest in comparison with the diameter of the internal fluid inflow 98a and in comparison with the diameter of the individual internal-fluid outlet openings 48a, 50a, 52a. The diameter of the individual internal-fluid outlet openings 48a, 50a, 52a is in this case formed as the smallest in comparison with the diameter of the internal fluid inflow 98a and in comparison with the diameter of the transitional space 100a. The diameter of the individual internal-fluid outlet openings 48a, 50a, 52a corresponds to the diameter of the respective through-opening of the individual channels 32a, 34a, 36a.

The inflow element 92a, the transitional element 94a, the supporting element 38a and the channels 32a, 34a, 36a are formed as one piece. Consequently, the internal-fluid feeding-in unit 30a is formed as one piece. In principle, it is also conceivable that the inflow element 92a, the transitional element 94a, the supporting element 38a and the channels 32a, 34a, 36a are formed as separate elements, which are then interconnected in particular by a thermal process for joining by material bonding, such as for example soldering, brazing or welding. As a result, the internal-fluid feeding-in unit 30a forms an assembly component, which is fitted in the spinneret unit in a single assembly step.

For the sealing of the extrusion space 28a, the spinneret unit has the cover unit 76a. The cover unit 76a comprises a spinneret cover 102a. The spinneret cover 102a has a lead-through opening 104a. The lead-through opening 104a has a diameter. The diameter of the lead-through opening 104a of the spinneret cover 102a is greater than the diameter of the inflow element 92a of the internal-fluid feeding-in unit 30a and less than the diameter of the transitional element 94a of the internal-fluid feeding-in unit 30a. The diameter of the lead-through opening 104a is minimally greater than the diameter of the inflow element 92a. The inflow element 92a penetrates through the spinneret cover 102a through the lead-through opening 104a. The lead-through opening 104a has the diameter by which a circumference of the lead-through opening 104a lies exactly against a circumference of the inflow element 92a. The lead-through opening 104a consequently has the diameter by which a material of the spinneret cover 102a lies exactly against a material of the leading-through inflow element 92a and against a material of the transitional element 94a arranged under the spinneret cover 102a. The spinneret cover 102a and the internal-fluid feeding-in unit 30a form an interlocking engagement counter to the extrusion direction 46a. This interlocking engagement is achieved by the lying of the spinneret cover 102a on the transitional element 94a. The lead-through opening 104a is formed as a bore in the spinneret cover 102a.

For providing an interlocking engagement of the internal-fluid feeding-in unit 30a and the extrusion unit 26a counter to the extrusion direction 46a, and consequently for the connection or fastening of the internal-fluid feeding-in unit 30a in the extrusion unit 26a, the cover unit 76a has four interlocking engagement elements 106a, 108a, 110a, 112a. The spinneret cover 102a is connected with interlocking engagement to the extrusion element 78a by the four interlocking engagement elements 106a, 108a, 110a, 112a. The four interlocking engagement elements 106a, 108a, 110a, 112a are formed as screws.

In principle, the extrusion element 78a and/or the internal-fluid feeding-in unit 30a may be produced from a solid material. In this case, the extrusion space 28a and the interior space of the spinneret unit are removed from the solid material by suitable milling tools. In this case, the extrusion unit 26a and/or the internal-fluid feeding-in unit 30a are formed as a material that is not removed from the solid material.

For controlling the temperature of the extrusion unit 26a, the internal-fluid feeding-in unit 30a and the cover unit 76a, the spinneret unit has a heating element that is not represented any more specifically. The heating element heats the extrusion unit 26a, the internal-fluid feeding-in unit 30a and/or the cover unit 76a to a specific temperature.

The multi-channel membrane is produced by the spinneret unit described above. To form the outer membrane surface 10a of the multi-channel membrane, in the extrusion operation the polymer solution is extruded at a defined extrusion rate through the extrusion unit 26a or through the extrusion space 28a in the extrusion direction 46a. The polymer solution is forced through the extrusion space 28a of the extrusion element 78a in the extrusion direction 46a. To form the inner membrane surface 12a, the polymer solution is extruded between the three channels 32a, 34a, 36a, whereby the three inner channel surfaces 60a, 62a, 64a and the three inner channels 14a, 16a, 18a of the multi-channel membrane form.

A single coagulating agent is used for the coagulation. The coagulating agent is formed as water. In this exemplary embodiment, the internal fluid consists of a single constituent. The internal fluid corresponds to the coagulating agent. The internal fluid and the coagulating agent consequently both consist of water. The solvent is consequently removed from the polymer with water. The extrusion rate is 3 meters per minute.

The polymer-solution outlet opening 54a of the extrusion element 78a and the internal-fluid outlet openings 48a, 50a, 52a of the inner channel unit 30a are arranged in the coagulating agent or in a coagulating agent bath. The polymer-solution outlet opening 54a and the internal-fluid outlet openings 48a, 50a, 52a are arranged in the coagulating agent in the extrusion operation. The spinneret unit is arranged partially in the coagulating agent in the extrusion operation. The polymer solution is extruded directly into the coagulating agent, i.e. into the coagulating agent bath. The polymer coagulates in the single coagulating agent, whereby the actively separating layer 20a forms on the outer membrane surface 10a.

In the extrusion operation, the internal fluid is conducted simultaneously through the three channels 32a, 34a, 36a, and consequently through the interior space of the spinneret unit. The internal fluid and the polymer solution are in this case separated, in terms of flow, from one another by the three channels 32a, 34a, 36a. The separation in terms of flow of the polymer solution and the internal fluid ends at the internal-fluid outlet openings 48a, 50a, 52a. The separation in terms of flow of the polymer solution and the internal fluid ends in the extrusion space 28a or in the funnel-shaped polymer-solution outflow space 88a. As a result, the inner membrane surface 12a comes into contact with the internal fluid, whereby the actively separating layer 22a forms on the inner membrane surface 12a.

After the coagulation, that is to say solidification, of the dissolved polymer, the multi-channel membrane with the two actively separating layers 20a, 22a and the supporting layer 24a is obtained. The outer membrane surface 10a and the inner membrane surface 12a thereby each form an actively separating layer 20a, 22a. The internal fluid is washed out from the inner channels 14a, 16a, 18a in an intensive washing operation. The actively separating layers 20a, 22a are each formed as the actively filtering layer.

For influencing a formation of the actively separating layers 20a, 22a and the supporting layer 24a, the temperature of the spinneret unit and the coagulating agent is controlled. The temperature of the extrusion unit 26a, of the inner channel unit 30a and of the cover unit 76a is set by the heating element of the spinneret unit and a temperature of the coagulating agent is set by a further heating element that is not represented any more specifically. The temperature of the coagulating agent is 75° C.

In an aftertreatment operation, after the intensive washing operation the multi-channel membrane is conditioned or prepared for 24 hours in running water. After the conditioning of the multi-channel membrane in running water, the multi-channel membrane is conditioned further, first for 12 hours in a 0.1-1% sodium hypochloride solution and then for 12 hours in a 1-10% glycerin solution. After the conditioning, the multi-channel membrane is rinsed free of chemicals in running fresh water.

A microscopic detail of a multi-channel membrane according to the invention which has been produced by the spinneret unit described above and the method described above is partially represented in a cross section in FIG. 6. The multi-channel membrane has the actively separating layer 20a on the outer membrane surface 10, an actively separating layer 22a on the inner channel surface 58a or on the inner membrane surface 12a and a supporting layer 24a arranged between the actively separating layers 20a, 22a.

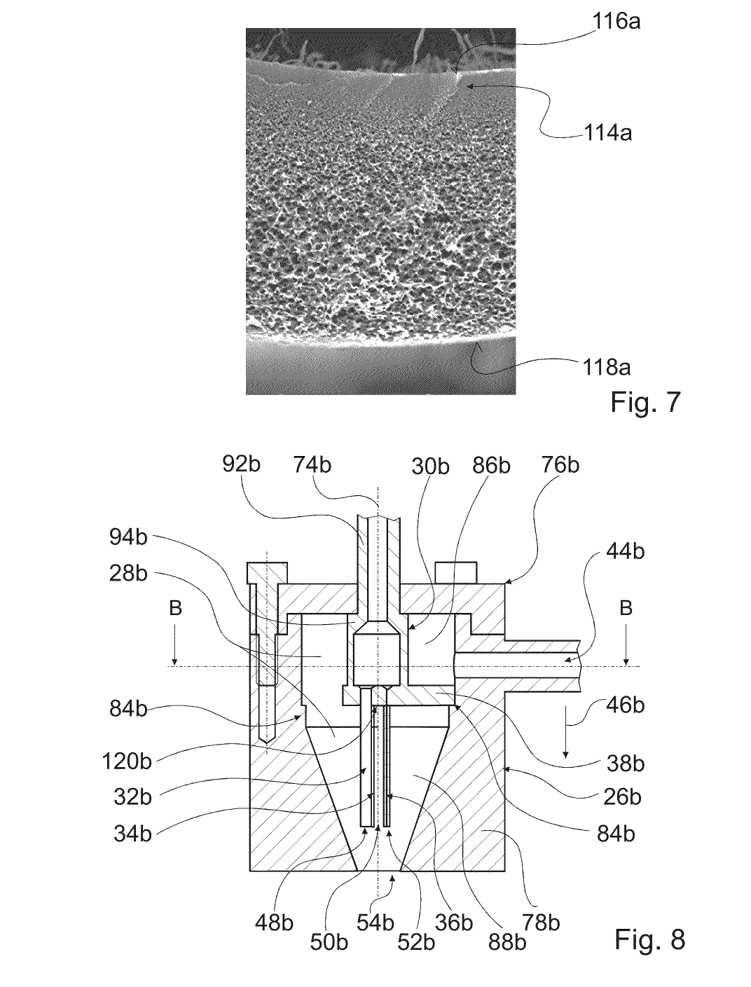

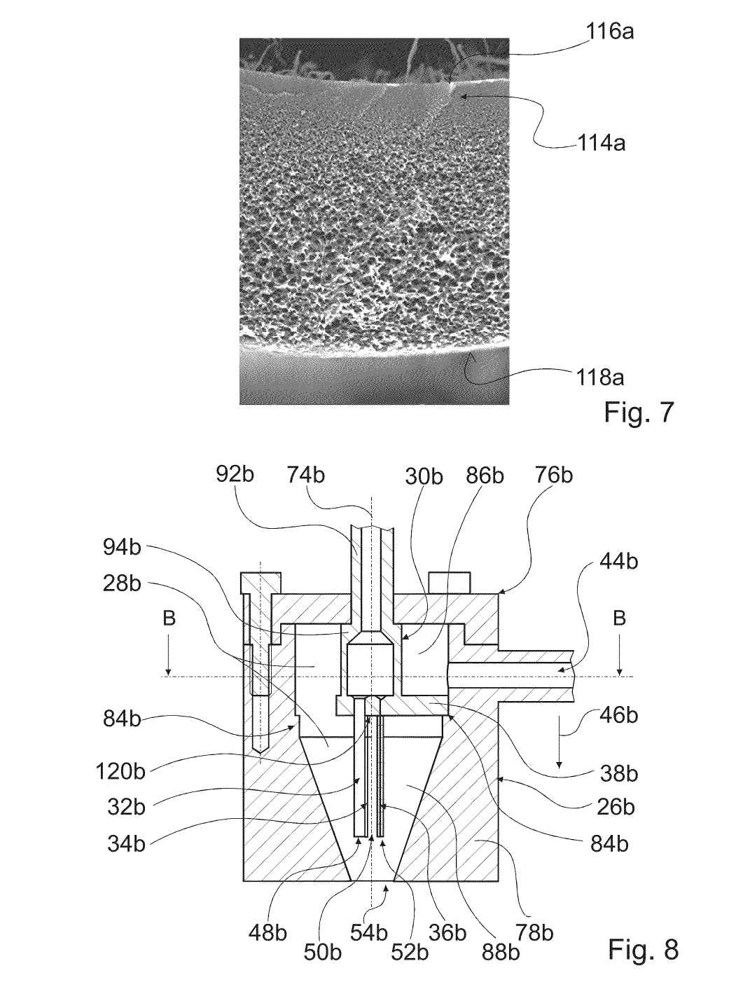

For comparison, a microscopic detail of a multi-channel membrane that just has one actively separating layer 114a on an inner channel surface 116a is represented in cross section in FIG. 7. An outer membrane surface 118a does not have an actively separating layer.

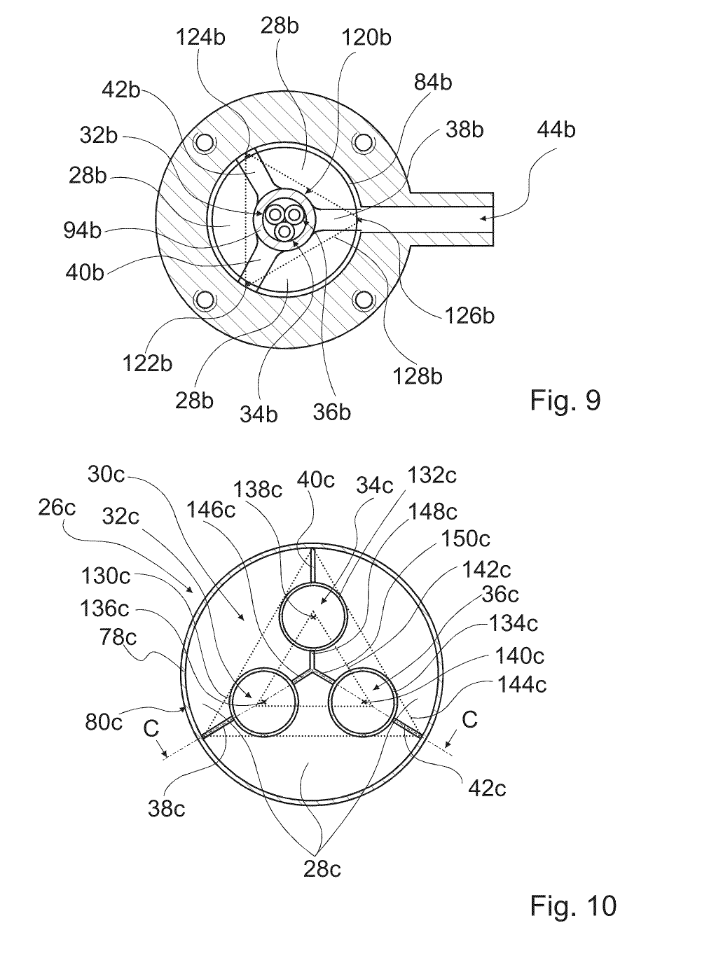

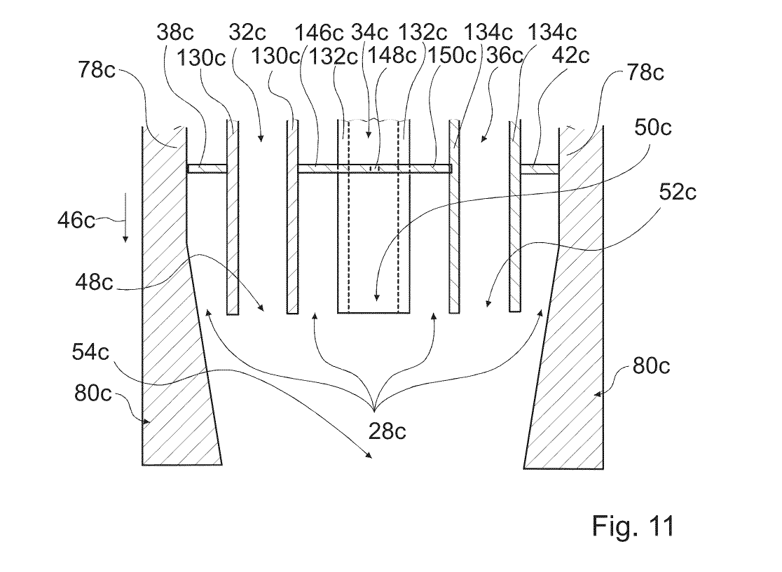

FIGS. 8 to 11 show two further exemplary embodiments of the spinneret unit according to the invention for producing the multi-channel membrane according to the invention by the method according to the invention. The following descriptions are confined essentially to the differences between the exemplary embodiments, while reference can be made to the description of the other exemplary embodiments, in particular of FIGS. 1 to 6, with respect to components, features and functions that remain the same. To differentiate between the exemplary embodiments, the letter a in the reference signs of the exemplary embodiment in FIGS. 1 to 6 is replaced by the letter b in the reference signs of the exemplary embodiment in FIGS. 8 and 9 and by the letter c in the reference signs of the exemplary embodiment in FIGS. 10 and 11. With respect to components that are designated the same, in particular with respect to components with the same reference signs, reference can also be made in principle to the drawings and/or the description of the other exemplary embodiment, in particular of FIGS. 1 to 6.

FIGS. 8 and 9 illustrate the second exemplary embodiment of a spinneret unit for producing the multi-channel membrane described above by the method described above. In FIG. 8, the spinneret unit is represented in a longitudinal section (along the sectional lines A-A according to FIG. 3). In FIG. 9, the spinneret unit is represented in a cross section along the sectional lines B-B.

The spinneret unit has an extrusion unit 26b with an extrusion element 78b, which an extrusion space 28b forms for conducting a polymer solution. The extrusion space 28b is formed partially as a funnel. The extrusion space 28b is subdivided into a polymer-solution inflow space 86b and a polymer-solution outflow space 88b.

The spinneret unit also has an inner channel unit 30b, which for conducting an internal fluid has three channels 32b, 34b, 36b, which are arranged within the extrusion space 28b and each comprise an internal-fluid outlet opening 48b, 50b, 52b, which are arranged within the extrusion space 28b.

The inner channel unit 30b has an inflow element 92b, a transitional element 94b and, as a difference from the previous exemplary embodiment, three supporting elements 38b, 40b, 42b. The supporting elements 38b, 40b, 42b are all arranged within the extrusion space 28b. The supporting elements 38b, 40b, 42b all lie against a supporting element 84b within the extrusion space 28b, and are consequently supported on the extrusion element 78b. The supporting elements 38b, 40b, 42b are arranged downstream of a polymer solution inflow 44b and upstream of a polymer-solution outlet opening 54b in an extrusion direction 46b.

The supporting elements 38b, 40b, 42b have a common central region 120b. The supporting elements 38b, 40b, 42b are interconnected by the central region 120b. The central region 120b is circularly formed in a cross section. The central region 120b is cylindrical. The central region 120b has a diameter which corresponds to a diameter of the transitional element 94b. The central region 120b has a central point, through which a longitudinal axis 74b extends. The three channels 32b, 34b, 36b pass completely through the central region 120b parallel to the longitudinal axis 74b. The three channels 32b, 34b, 36b pass through the supporting elements 38b, 40b, 42b in the central region 120b. The supporting elements 38b, 40b, 42b position the channels 32b, 34b, 36b in relation to one another with the central region 120b.

The supporting elements 38b, 40b, 42b are made of an identical material to the inflow element 92a and the transitional element 94a. The supporting elements 38b, 40b, 42b are formed as one piece with the inflow element 92a and the transitional element 94a.

The supporting element 38b is arranged in the region of the polymer solution inflow 44b. The supporting elements 38b, 40b, 42b are arranged symmetrically in relation to one another. The supporting elements 38b, 40b, 42b are distributed uniformly in the extrusion space 28b on a plane which is aligned perpendicularly to the extrusion direction 46b and perpendicularly to the longitudinal axis 74b.

The supporting elements 38b, 40b, 42b are arranged at three corners 122b, 124b, 126b of an equilateral or equiangular triangle 128b. The three corners 122b, 124b, 126b of the triangle 128b defined by the arrangement of the supporting elements 38b, 40b, 42b lie on the supporting element 84b of the extrusion element 78b. The three corners 122b, 124b, 126b are arranged within the extrusion element 78b. The three channels 32b, 34b, 36b, the inflow element 92b, the transitional element 94b and the central region 120b are arranged in cross section within the equilateral triangle 128b defined by the arrangement of the three supporting elements 38b, 40b, 42b.

As a difference from the previous exemplary embodiment, the supporting elements 38b, 40b, 42b are each formed as a bar.

FIGS. 10 and 11 illustrate the third exemplary embodiment of a spinneret unit for producing the multi-channel membrane described above by the method described above. In FIG. 9, the spinneret unit is represented schematically in a cross section. In FIG. 9, the spinneret unit is represented schematically and partially in a longitudinal section along the sectional lines C-C.

The spinneret unit has an extrusion unit 26c with an extrusion element 78c, which forms an extrusion space 28c for conducting a polymer solution. The extrusion space 28c is partially formed as a funnel.

The spinneret unit also has an inner channel unit 30c, which for conducting an internal fluid has three channels 32c, 34c, 36c, which are arranged within the extrusion space 28c and each comprise an internal-fluid outlet opening 48c, 50c, 52c, which are arranged within the extrusion space 28c.

The channel 32c is defined by a channel wall 130c. The channel 34c is defined by a channel wall 132c. The channel 36c is defined by a channel wall 134c. The channels 32c, 34c, 36c each have a through-opening. The channels 32c, 34c, 36c, and consequently the through-openings, each have a central point 136c, 138c, 140c. The three channels 32c, 34c, 36c are arranged symmetrically in relation to one another. The central points 136c, 138c, 140c are arranged at three corners of an equilateral or equiangular triangle 142c.

The inner channel unit 30c has three supporting elements 38c, 40c, 42c. The supporting elements 38c, 40c, 42c are all arranged within the extrusion space 28c. The supporting elements 38c, 40c, 42c are all arranged upstream of a polymer-solution outlet opening 54c in the extrusion direction 46c. As a difference from the previous exemplary embodiments, the supporting elements 38c, 40c, 42c are each fixedly connected to a wall 80c of the extrusion element 78c. In principle, the extrusion element 78c may, as in the previous examples, have a supporting element on which the supporting elements 38c, 40c, 42c lie.

The supporting element 38c connects the wall 80c of the extrusion element 78c to the channel wall 130c of the channel 32c. The supporting element 40c connects the wall 80c of the extrusion element 78c to the channel wall 132c of the channel 34c. The supporting element 42c connects the wall 80c of the extrusion element 78c to the channel wall 134c of the channel 36c.

The three supporting elements 38c, 40c, 42c are arranged symmetrically in relation to one another. The supporting elements 38c, 40c, 42c are arranged at three corners of an equilateral or equiangular triangle 144c. The three corners of the triangle 144c defined by the arrangement of the supporting elements 38c, 40c, 42c lie on the wall 80c of the extrusion element 78c.

The three channels 32c, 34c, 36c are arranged within the equilateral triangle 144c defined by the arrangement of the three supporting elements 38c, 40c, 42c. The triangle 142c defined by the arrangement of the central points 136c, 138c, 140c of the channels 32c, 34c, 36c is arranged within the triangle 144c defined by the arrangement of the three supporting elements 38c, 40c, 42c, sides of the triangles 142c, 144c lying parallel to one another.

For positioning the three channels 32c, 34c, 36c in relation to one another and for stabilizing the three channels 32c, 34c, 36c or for connecting the three channels 32c, 34c, 36c to one another, as a difference from the previous exemplary embodiments, the inner channel unit 30c has three connecting elements 146c, 148c, 150c. The three connecting elements 146c, 148c, 150c are identically formed. The connecting element 146c connects the channel wall 130c of the channel 32c to the channel wall 132c of the channel 34c. The connecting element 148c connects the channel wall 132c of the channel 34c to the channel wall 134c of the channel 36c. The connecting element 150c connects the channel wall 134c of the channel 36c to the channel wall 130c of the channel 32c. The three connecting elements 146c, 148c, 150c position or connect the three channels 32c, 34c, 36c at an identical distance from one another.

The three connecting elements 146c, 148c, 150c are configured as one piece. The three connecting elements 146c, 148c, 150c formed as one piece are formed as a star. In principle, the three connecting elements 146c, 148c, 150c may also be formed separately from one another and connect or position the channels 32c, 34c, 36c separately from one another.

The supporting elements 38c, 40c, 42c fix the three channels 32c, 34c, 36c in the extrusion space 28c. The supporting elements 38c, 40c, 42c and the connecting elements 146c, 148c, 150c each have an extent oriented in the extrusion direction 46c. The extents, oriented in the extrusion direction 46c, of the supporting elements 38c, 40c, 42c and of the connecting elements 146c, 148c, 150c are identical. The extents, oriented in the extrusion direction 46c, of the supporting elements 38c, 40c, 42c and of the connecting elements 146c, 148c, 150c are significantly less than axial extents, oriented in the extrusion direction 46c, of the channels 32c, 34c, 36c, and consequently of the extrusion element 78c. In principle, the extents, oriented in the extrusion direction 46c, of the supporting elements 38c, 40c, 42c and of the connecting elements 146c, 148c, 150c may also differ.

The extrusion element 78c, the three channels 32c, 34c, 36c, the supporting elements 38, 40, 42 and the connecting elements 146c, 148c, 150c are interconnected in particular by a thermal process for joining by material bonding, such as for example soldering, brazing or welding. In principle, the extrusion element 78c, the three channels 32c, 34c, 36c, the supporting elements 38c, 40c, 42c and the connecting elements 146c, 148c, 150c can be produced from a solid material.

In this case, the extrusion space 28c and an interior space of the spinneret unit are removed from the solid material by suitable milling tools. In this case, the wall 80c of the extrusion element 78c, the three channel walls 130c, 132c, 134c, the supporting elements 38c, 40c, 42c and the connecting elements 146c, 148c, 150c are formed as a material that is not removed from the solid material.

1. A multi-channel membrane, in particular for treatment of liquids, comprising:
at least one outer membrane surface; and
one inner membrane surface which forms at least two longitudinally extending inner channels, which are enclosed by the outer membrane surface, wherein
the outer membrane surface and the inner membrane surface each form an actively separating layer, and
a median pore size of the actively separating layer of the outer membrane surface differs from a median pore size of the actively separating layer of the outer membrane surface.

2. The multi-channel membrane as claimed in claim 1, wherein
the inner membrane surface forms three inner channels.

3. The multi-channel membrane as claimed in claim 1, wherein
a supporting layer, which is enclosed by the actively separating layer on the outer membrane surface and which encloses the actively separating layer on the inner membrane surface, having an at least substantially constant porosity.

4. The multi-channel membrane as claimed in claim 3, wherein
a median pore size of the actively separating layers is at least approximately ten times smaller than a median pore size of the supporting layer.

5. A spinneret unit, in particular for producing a multi-channel membrane as claimed in claim 1, comprising at least one extrusion unit, which forms at least one extrusion space for conducting a polymer solution, and comprising at least one internal-fluid feeding-in unit, which has at least two channels arranged within the extrusion space for conducting an internal fluid, wherein
the internal-fluid feeding-in unit has at least one supporting element, which is arranged within the extrusion space, and
the internal-fluid feeding-in unit has at least one internal-fluid outlet opening which is arranged with in the extrusion space.

6. The spinneret unit as claimed in claim 5, wherein
the extrusion unit has at least one polymer solution inflow, and in that at least the one supporting element is arranged downstream of the polymer solution inflow in an extrusion direction.

7. (canceled)

8. The spinneret unit at least as claimed in claim 6, wherein
the extrusion unit has at least one polymer-solution outlet opening and the supporting element has at least one through-opening which is intended for the purpose of connecting the polymer solution inflow and the polymer-solution outlet opening in terms of flow.

9. The spinneret unit as claimed in claim 5, wherein
the at least one supporting element is formed as a bar.

10. The spinneret unit as claimed in claim 5, wherein
the extrusion space is formed at least partially as a funnel.

11. A method for producing a multi-channel membrane, in particular a multi-channel membrane as claimed in claim 1, in which method a polymer solution is extruded to form an outer membrane surface of the multi-channel membrane, the polymer solution being extruded between at least two channels to form an inner membrane surface of the multi-channel membrane, and an internal fluid that is, in terms of flow, separated from the extruding polymer solution being conducted through the at least two channels, the inner membrane surface and the outer membrane surface of the multi-channel membrane each forming an actively separating layer, wherein
a single coagulating agent is used and the polymer solution is extruded directly into the coagulating agent.

12-13. (canceled)

14. The method as claimed in claim 10, wherein
the internal fluid corresponds at least partially to the coagulating agent.

15. The method as claimed in claim 11, wherein
water is used as the coagulating agent.

16. The multi-channel membrane as claimed in claim 2, wherein
a supporting layer, which is enclosed by the actively separating layer on the outer membrane surface and which encloses the actively separating layer on the inner membrane surface, the supporting layer having an at least substantially constant porosity.

17. A spinneret unit, in particular for producing a multi-channel membrane as claimed in claim 2, comprising at least one extrusion unit, which forms at least one extrusion space for conducting a polymer solution, and comprising at least one internal-fluid feeding-in unit, which has at least two channels arranged within the extrusion space for conducting an internal fluid, wherein
the internal-fluid feeding-in unit has at least one supporting element, which is arranged within the extrusion space, and
the internal-fluid feeding-in unit has at least one internal-fluid outlet opening which is arranged with in the extrusion space.

18. A spinneret unit, in particular for producing a multi-channel membrane as claimed in claim 3, comprising at least one extrusion unit, which forms at least one extrusion space for conducting a polymer solution, and comprising at least one internal-fluid feeding-in unit, which has at least two channels arranged within the extrusion space for conducting an internal fluid, wherein
the internal-fluid feeding-in unit has at least one supporting element, which is arranged within the extrusion space, and
the internal-fluid feeding-in unit has at least one internal-fluid outlet opening which is arranged with in the extrusion space.

19. A spinneret unit, in particular for producing a multi-channel membrane as claimed in claim 4, comprising at least one extrusion unit, which forms at least one extrusion space for conducting a polymer solution, and comprising at least one internal-fluid feeding-in unit, which has at least two channels arranged within the extrusion space for conducting an internal fluid, wherein
the internal-fluid feeding-in unit has at least one supporting element, which is arranged within the extrusion space, and
the internal-fluid feeding-in unit has at least one internal-fluid outlet opening which is arranged with in the extrusion space.

20. The spinneret unit as claimed in claim 6, wherein
the at least one supporting element is formed as a bar.

21. The spinneret unit as claimed in claim 8, wherein
the at least one supporting element is formed as a bar.

22. The spinneret unit as claimed in claim 6, wherein
the extrusion space is formed at least partially as a funnel.

23. The spinneret unit as claimed in claim 8, wherein
the extrusion space is formed at least partially as a funnel.
